(19) United States
(12) Patent Application Publication
(10) Pub. No.: US 2021/0243278 A1
(43) Pub. Date: Aug. 5, 2021

(54) COMMUNICATION SYSTEM AND MOVING METHOD

(71) Applicant: Nippon Telegraph and Telephone Corporation, Tokyo (JP)

(72) Inventors: Koji Sugisono, Tokyo (JP); Aki Fukuoka, Tokyo (JP); Hirofumi Yamazaki, Tokyo (JP)

(21) Appl. No.: 17/267,371

(22) PCT Filed: Aug. 9, 2019
(86) PCT No.: PCT/JP2019/031757

§ 371 Date: Feb. 9, 2021

(30) Foreign Application Priority Data
Aug. 15, 2018 (JP) 2018-153008

(51) Int. Cl. H04L 29/08; H04L 12/851

(52) U.S. Cl. CPC H04L 67/34; H04L 47/2441; H04L 67/1095

(57) ABSTRACT

An instance running device (10) determines, based on VNF instances through which a traffic flow passes and an order of software pieces through which the VNF instances pass, an order of the VNF instances to be migrated, and performs control so that the VNF instances are migrated to another instance running device (10) on the basis of the determined order of the software pieces migrated.

### TECHNICAL FIELD

The present invention relates to a communication system and a migration method.

### BACKGROUND ART

In recent years, service function chaining in which packet processing is executed in a determined order for a traffic flow is getting popular. The packet processing is executed by a software-implemented virtual network function (VNF) instance. A traffic flow is transferred between the VNF instances using a tunneling technique. A set of transfer tunnel paths connecting the VNF instances to each other is referred to as a service chain.

The VNF instances are relocated to optimize network resource. In this context, a VNF instance can be migrated to and run on another server using a technique known as live migration. To implement the live migration, the VNF instance needs to be stopped for a time period with a length in a unit of milliseconds. During the time period, packet flow transfer stops and thus flow interruption occurs.

A plurality of VNF instances forming the service chain are located in the identical server so that packets are transferred between the VNF instances via a shared memory enabling high speed transfer. When the migration timings of these VNF instances do not match, a VNF instance migrated earlier and a VNF instance being migrated run on different servers. Thus, the packet flow transferred between them is transferred over the network. Such a flow results in a link resource in the network being consumed more than necessary. In view of this, a time consumed by the later migration of the VNF instance is required to be shortened.

The VNF instances running on the identical server share the band of the output link, and involve a large amount of data to be updated. Thus, it is difficult to migrate all the VNF instances at once in parallel. This leads to the scenario where one VNF instance is transmitted and then the next VNF instance is transmitted.

The flow interruption occurs within time periods including: a time period in which the VNF instance is stopped for transmitting data updated frequently; a time period in which preparation is performed for executing the packet processing on a migration destination; and a time period in which transfer path information in a data network is updated so that the traffic flow can reach the migration destination server. In the last two time periods, the data transmission has been already completed for the VNF instance migrated earlier. Thus, a band can be used for migrating the next VNF instance, and thus the migration starts. Thus, the flow interruption occurs until the earlier VNF instance starts processing packets, after the migration for the next VNF instance has started.

While the flow interruption is occurring due to the migration of the VNF instance, no packet reaches the VNF instance on the downstream side of the VNF instance being migrated. The VNF instance executes the packet processing while being migrated. The VNF instance updates data such as local variables during the packet processing. In live migration, data in the VNF instance is entirely synchronized between the migration destination server and the migration source server. The processing by the VNF instance resumes on the migration destination server after the synchronization is completed. Thus, the updated data is synchronized.

The flow interruption leads to reduction of the amount of reaching packets. As a result, the amount of data to be updated also decreases. Thus, the migration of the downstream side VNF instance results in a smaller amount of data synchronized by live migration. Thus, migration time for the VNF instance can be shortened.

Packets continue to reach the VNF instance on the upstream side of the VNF instance being migrated. The packet processing is executed, and thus data is updated. Thus, when such a VNF instance is migrated, a large amount of data needs to be synchronized. This results in a longer time required for migrating the VNF instance. There is a method for migrating such a VNF instance (see, for example, Non Patent Literature 1).

### CITATION LIST

### Non Patent Literature

Non Patent Literature 1: Jie Zheng and T. S. Eugene Ng and Kunwadee Sripanidkulchai and Zhaolei Liu, “COMMA: Coordinating the Migration of Multi-tier Applications”, Proc. ACM SIGPLAN/SIGOP Int. Conf. on Virtual Execution Environments (VEE 2014), March 2014, pp. 1 to 12

### SUMMARY OF THE INVENTION

### Technical Problem

However, the known technique has a problem of involving along migration time for the VNF instance, leading to the traffic flowing into the network for a long period of time, resulting in a large amount of resource consumed in the network. For example, in the method of migrating a VNF instance described above, the order in which the VNF instances are migrated is not specifically defined. This leads to a scenario where one VNF instance is transferred and then a VNF instance on the upstream side is migrated. In such a scenario, when the packet processing is executed on the upstream side, migration time becomes long, leading to the traffic flowing into the network for a long period of time, resulting in a large amount of resource consumed in the network.

### Means for Solving the Problem

To solve the problem described above and achieve the object, a communication system of the present invention includes a determination unit configured to determine based on software pieces through which a traffic flow passes, the software pieces running on a predetermined server, and on an order of the software pieces through which the traffic flow passes, a migration order of the software pieces to be migrated, and a migration control unit configured to perform control so that the software pieces are migrated to another server based on the migration order of the software pieces determined by the determination unit.

A migration method performed by a communication system according to the present invention includes determining, based on software pieces through which a traffic flow passes, the software pieces running on a predetermined server, and on an order of the software pieces through which the traffic flow passes, a migration order of the software pieces to be migrated, and performing control so that the software pieces are migrated to another server based on the determined migration order of the software pieces to be migrated according to the determining.

### Effects of the Invention

With the present invention, the time during which traffic flow into the network is shortened so that an effect of reducing the amount of network resource consumed can be obtained.

### BRIEF DESCRIPTION OF DRAWINGS

FIG. 1 is a diagram illustrating one example of a configuration of a communication system according to a first embodiment.

FIG. 2 is a diagram illustrating an example of a flow table included in an instance running device.

FIG. 3 is a diagram illustrating processing for determining the migration order of VNF instances for a one-way flow.

FIG. 4 is a diagram illustrating the amount of overwritten data in the VNF instances on the upstream and downstream sides, in a case where the migration of the intermediate VNF instance is completed.

FIG. 5 is a diagram illustrating processing for determining the migration order of VNF instances for a bidirectional flow.

FIG. 6 is a diagram illustrating processing for determining the migration order of VNF instances in a case where there are a plurality of traffic flows.

FIG. 7 is a flowchart illustrating an example of processing executed by the instance running device according to the first embodiment.

FIG. 8 is a diagram illustrating a computer that executes a program.

### DESCRIPTION OF EMBODIMENTS

Embodiments of a communication system and a migration method according to the present application will be described below in detail on the basis of the drawings. Note that the communication system and the migration method according to the present disclosure are not limited by the embodiments.

### First Embodiment

In the following embodiment, the configuration of a communication system according to a first embodiment and a processing flow in the communication system will be described in this order, and finally, the effects according to the first embodiment will be described.

Configuration of Communication System

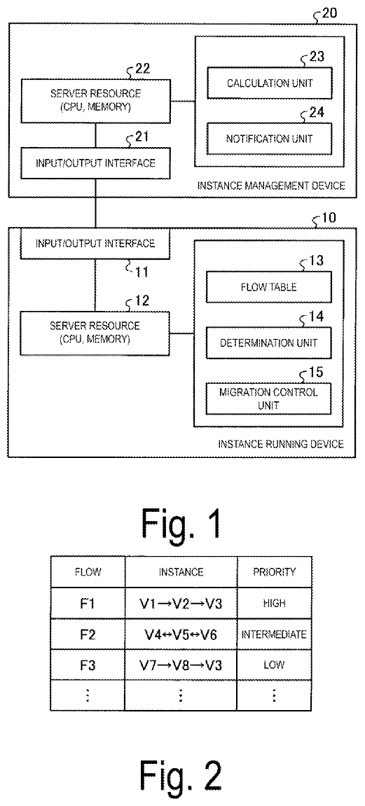

First of all, a configuration of a communication system according to a first embodiment will be described with reference to FIG. 1. FIG. 1 is a diagram illustrating one example of a configuration of the communication system according to the first embodiment. The communication system according to the first embodiment includes an instance running device 10 and an instance management device 20. Note that the configuration illustrated in FIG. 1 is merely an example, and the specific configuration and the number of devices are not particularly limited. Furthermore, the functions of the instance running device 10 and the instance management device 20 are merely examples, and some or all of the functions of the instance running device 10 may be included in the instance management device 20.

The instance running device 10 is a device on which a VNF instance (software) runs. The instance running device 10 includes an input/output interface 11, a server resource 12, a flow table 13, a determination unit 14, and a migration control unit 15. The input/output interface 11 controls communications related to various types of information, and transmits and receives data to and from the instance management device 20, for example. The server resource 12 is, for example, a physical resource such as a CPU or a memory, and is a resource for operating a VNF instance.

The flow table 13 is a table storing VNF instances through which a traffic flow passes. Specifically, the flow table 13 stores migration target VNF instances and a traffic flow that passes through the VNF instances that are the migration targets received from the instance management device 20.

For example, the flow table 13 stores “FLOW” indicating the identifier for uniquely identifying the traffic flow, “INSTANCE” indicating the VNF instances through which the traffic flow passes, and “PRIORITY” indicating the priority of the traffic flow in association with each other, as in the example illustrated in FIG. 2.

Referring to the specific example illustrated in FIG. 2, for example, a traffic flow “F” is a one-way flow that passes through VNF instances “V1”, “V2”, and “V3” in this order, with the priority set to be “high”. A traffic flow “F2” is a bidirectional flow that passes through VNF instances “V4”, “V5”, and “V6” in this order, and passes through the VNF instances “V6”, “V5”, and “V4” in this order, with the priority set to be “intermediate”.

The determination unit 14 determines the order of VNF instances to be migrated on the basis of the VNF instances though which the traffic flow passes, the VNF instances running on the instance running device 10, and of the order of the VNF instances through which the traffic flow passes.

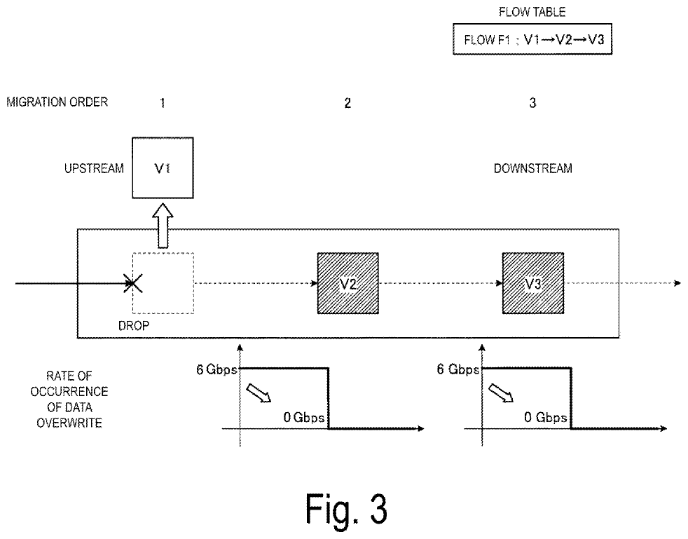

For example, in a case where the traffic flow is a one-way flow, the determination unit 14 determines a migration schedule so that the VNF instances are migrated in order from the upstream side. Referring now to FIG. 3, processing for determining the migration order of VNF instances for the one-way flow will be described. FIG. 3 is a diagram illustrating processing for determining the migration order of VNF instances for the one-way flow. As illustrated in FIG. 3 as an example, when the flow F1 is a one-way flow passing through the VNF instances “V1”, “V2”, and “V3” in this order, the order is determined so that the VNF instance “V1” on the upstream side is migrated first, the VNF instance “V2” is migrated second, and the VNF instance “V3” is migrated third and final.

The determination unit 14 thus determining the VNF instances to be migrated from the upstream side results in no traffic flow reaching the VNF instance on the downstream side. Thus, the amount of data that needs to be synchronized due to the packet processing decreases, whereby the time required for migrating the VNF instances can be shortened. Note that in the example of FIG. 3, rate of occurrence of data overwrite is illustrated to be lowered due to the packet processing being stopped because the traffic flow does not reach the VNF instance on the downstream side. With the migration time thus shortened, duration of a scenario where the traffic flow is transferred between the VNF instances through the network can be shortened. This improves a scenario where the traffic flow consumes the network resources.

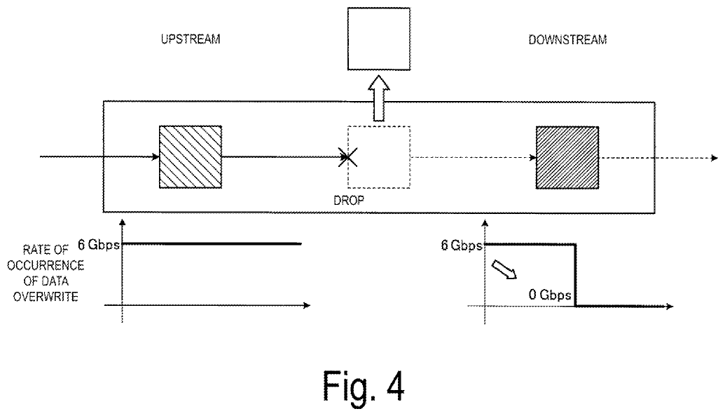

Now an amount of overwritten data in the VNF instances on the upstream and downstream sides in a possible case where the migration starts from the intermediate VNF instance will be described with reference to an example illustrated in FIG. 4. FIG. 4 is a diagram illustrating the amount of overwritten data in the VNF instances on the upstream and downstream sides, in a case where the migration of the intermediate VNF instance is completed.

As illustrated in FIG. 4 as an example, in this possible case where the migration starts from the intermediate VNF instance instead of the VNF instance on the upstream side, the traffic flow reaches the VNF instance on the upstream side and the packet processing continues. This results in a large amount of data to be synchronized due to the packet processing (the amount of overwritten data), and the VNF instance migration time cannot be shortened. In the example of FIG. 4, no traffic flow reaches the downstream VNF instance, and thus the packet processing stops, whereby a rate of occurrence of data overwrite is lowered. On the other hand, it is illustrated in the figure that when the traffic flow reaches the VNF instance on the upstream side, the packet processing continues and the rate of occurrence of the data overwrite remains unchanged.

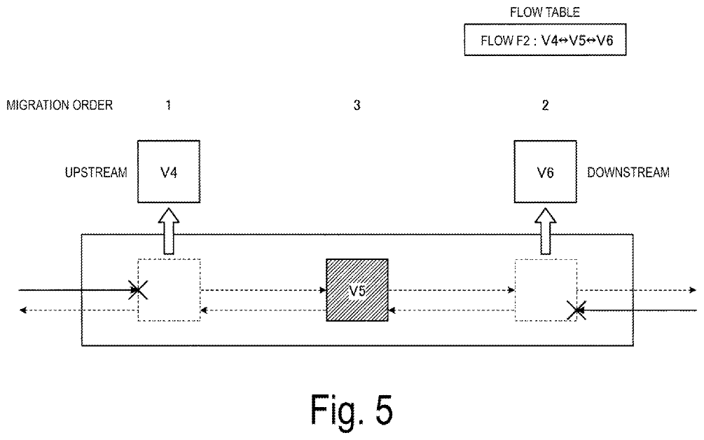

For example, in a case where the traffic flow is a bidirectional flow, the determination unit 14 determines the order so that the VNF instance at one of upstream and downstream ends is first migrated, and then the VNF instance on the other end is migrated. Referring now to FIG. 5, processing for determining the migration order of VNF instances for the bidirectional flow will be described. FIG. 5 is a diagram illustrating processing for determining the migration order of VNF instances for the bidirectional flow.

As illustrated in FIG. 5 as an example, the traffic flow “F2” is a bidirectional flow that passes through VNF instances “V4”, “V5”, and “V6” in this order, and also passes through the VNF instances “V6”, “V5”, and “V4” in this order. Note that in the example of FIG. 5, the side of the VNF instance “V4” is defined as the upstream and the side of the VNF instance “V6” is defined as the downstream. In such a case, the order is determined so that the VNF instance “V4” at the upstream end is migrated first, the VNF instance “V6” at the downstream end is migrated second, and the intermediate VNF instance “V5” is migrated third and final.

When the determination unit 14 processes the bidirectional flow through the VNF instances in this manner, migration of the VNF instances “V4” and “V6” at ends in both directions of the flow results in the packet of the flow in both directions discarded in the VNF instances “V4” and “V6”. Thus, no packet reaches the VNF instance “V5” in between, whereby the amount of packets processed by this VNF instance is also reduced. As a result, the time required for migrating the VNF instance in between can be shortened because there is not data that needs to be synchronized.

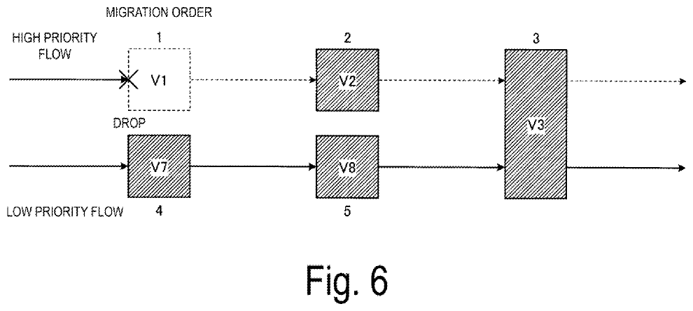

For example, when there area plurality of traffic flows, the determination unit 14 determines the order so that the VNF instance through which a traffic flow with high priority set in advance passes is migrated earlier than the VNF instance through which a traffic flow with a low priority passes. Referring now to FIG. 6, processing for determining the migration order of VNF instances in the case where there are a plurality of traffic flows will be described. FIG. 6 is a diagram illustrating processing for determining the migration order of VNF instances in the case where there are a plurality of traffic flows.

As illustrated in FIG. 6, there are the traffic flow “F1” that passes through the VNF instances “V1”, “V2”, and “V3” in this order and the traffic flow “F3” that passes through the VNF instances “V7”, “V8”, and “V3”. Thus, both traffic flows pass through the VNF instance “V3”. The traffic flow “F” is a high priority flow with high priority set, and the traffic flow “F3” is a low priority flow with low priority set.

In such a case, the determination unit 14 determines the order of the VNF instances through which the high-priority traffic flow “F1” passes, so that the VNF instance “V1” on the upstream side is migrated first, the VNF instance “V2” is migrated second, and the VNF instance “V3” is migrated third and final. Then, the determination unit 14 determines the order of the remaining VNF instances through which the low-priority traffic flow “F2” passes, so that the VNF instance “V7” is migrated fourth, and the VNF instance “V8” is migrated fifth and final.

Referring back to FIG. 1, the migration control unit 15 performs control so that the VNF instances are migrated to another instance running device (not illustrated) in the VNF instance migration order determined by the determination unit 14.

The instance management device 20 manages the migration of the VNF instances to optimize the network resources. For example, the instance management device 20 manages the VNF instances running on the instance running device 10 and the traffic flow that passes the VNF instances, and designates the VNF instances as the migration targets and the traffic flow that passes through the VNF instances on the basis of the relationship between the traffic flow and the instances.

The instance management device 20 includes an input/output interface 21, a server resource 22, a calculation unit 23, and a notification unit 24. The calculation unit 23 calculates VNF instances that migrate in a predetermined way when the VNF instances need to be migrated, and a traffic flow that passes through the VNF instances.

The notification unit 24 notifies the instance running device 10 of the result of the calculation by the calculation unit 23. For example, the notification unit 24 give notice of the migration target VNF instances and the traffic flow that passes through the VNF instance that are the migration targets.

Flow of Processing by Communication System

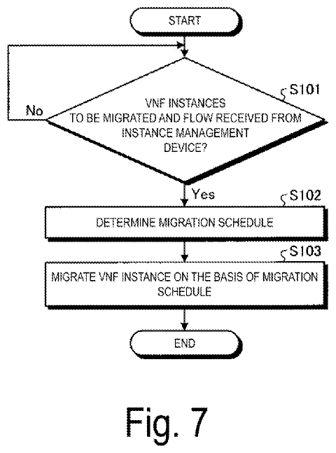

Next, a flow of processing by the instance running device 10 according to the first embodiment will be described with reference to FIG. 7. FIG. 7 is a flowchart illustrating an example of processing executed by the instance running device according to the first embodiment.

As illustrated in FIG. 7, upon receiving the migration target VNF instances and the traffic flow that passes through the migration target VNF instances from the instance management device 20 (Yes in step S101), the determination unit 14 of the instance running device 10 determines the migration schedule of the VNF instances (step S102).

For example, in a case where the traffic flow is a one-way flow, the determination unit 14 determines a migration schedule so that the VNF instances are migrated in order from the upstream side. For example, in a case where the traffic flow is a bidirectional flow, the determination unit 14 determines the order so that the VNF instance at one of upstream and downstream ends is first migrated, and then the VNF instance on the other end is migrated.

Then, the migration control unit 15 performs control so that the VNF instances are migrated to another instance running device on the basis of the migration schedule determined by the determination unit 14 (step S103).

### Effect of First Embodiment

As described above, the instance running device 10 of the communication system according to the first embodiment determines the order of VNF instances to be migrated on the basis of the VNF instances though which the traffic flow passes and the order of the VNF instances through which the VNF instances pass. Furthermore, the instance running device 10 performs control so that the VNF instances are migrated to another instance running device 10 on the basis of the VNF instance migration order determined. Thus, with the instance running device 10 according to the first embodiment, the migration time of the VNF instances is shortened, so that the time during which the traffic flows into the network is shortened, whereby the amount of network resources consumed can be reduced.

For example, the instance running device 10 thus determining the VNF instances to be migrated from the upstream side results in no traffic flow reaching the VNF instance on the downstream side. Thus, the amount of data that needs to be synchronized due to the packet processing decreases, whereby the time required for migrating the VNF instances can be shortened.

System Configuration and the Like

Each element of each apparatus illustrated is a functional concept and does not necessarily need to be physically configured as illustrated. That is, the specific form of distribution and integration of the apparatus is not limited to the illustrated form, and the entirety or a portion of the form can be configured by being functionally or physically distributed and integrated in any unit, depending on various loads, usage conditions, and the like. Further, all or any part of each processing function to be performed in each apparatus can be realized by the CPU and a program being analyzed and executed by the CPU, or can be realized as hardware by wired logic.

In addition, among processing described in the embodiments, all or some of processes described as being performed automatically can be manually performed, or all or some of processes described as being performed manually can be performed automatically by well-known methods. In addition, information including the processing procedures, the control procedures, the specific names, and various data and parameters described in the above-described document and drawings can be changed except for the case of special description.

Program

A program in which the processing executed by the devices described in the aforementioned embodiments is described in a computer-executable language can also be created. For example, a program in which the process that is executed by the devices in the communication system according to the embodiments has been described in a computer-executable language can be created. In such a case, the effect that is the identical as that in the embodiment described above can be obtained with the computer executing the program. Hereinafter, one example of the computer that executes the program will be described.

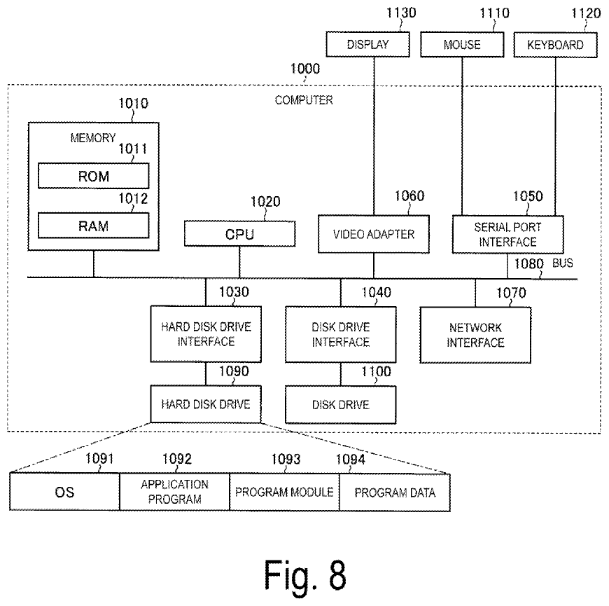

FIG. 8 is a diagram illustrating a computer that executes a control program. A computer 1000 includes, for example, a memory 1010 and a CPU 1020. In addition, the computer 1000 includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores a boot program, such as Basic Input Output System (BIOS), for example. The hard disk drive interface 1030 is connected to a hard disk drive 1090. The disk drive interface 1040 is connected to a disk drive 1100. A detachable storage medium such as a magnetic disk or an optical disc is inserted into the disk drive 1100. The serial port interface 1050 is connected to, for example, a mouse 1051 and a keyboard 1052. A video adapter 1060 is connected to, for example, a display 1061.

Here, the hard disk drive 1090 stores, for example, an OS 1091, an application program 1092, a program module 1093, and program data 1094. Tat is, a program defining each of processes of the devices is implemented as the program module 1093 in which computer-executable code has been described. The program module 1093 is stored in, for example, the hard disk drive 1090. For example, the program module 1093 for executing processing similar to the functional configuration in the device is stored in hard disk drive 1090. Note that the hard disk drive 1090 may be replaced with a solid state drive (SSD).

In addition, data used in the processing of the above-described embodiment is stored in, for example, the memory 1010 or the hard disk drive 1090, as the program data 1094. In addition, the CPU 1020 reads the program module 1093 and the program data 1094 stored in the memory 1010 and the hard disk drive 1090 to the RAM 1012 and executes them as necessary.

Note that the program module 1093 and the program data 1094 are not limited to being stored in the hard disk drive 1090, and may be stored, for example, in a removable storage medium, and read by the CPU 1020 via a disk drive 1100 or its equivalent. Alternatively, the program module 1093 and the program data 1094 may be stored in another computer connected through a network or a WAN. In addition, the program module 1093 and the program data 1094 may be read by the CPU 1020 from another computer through the network interface 1070.

### REFERENCE SIGNS LIST

10 Instance running device
11, 21 Input/output interface
12, 22 Server resource
13 Flow table
14 Determination unit
15 Migration control unit
20 Instance management device
23 Calculation unit
24 Notification unit

1. A communication system comprising:
a determination unit configured to determine, based on software pieces through which a traffic flow passes, the software pieces running on a predetermined server, and determine, based on an order of the software pieces through which the traffic flow passes, a migration order of the software pieces to be migrated; and
a migration control unit configured to perform a control so that the software pieces are migrated to another server based on the migration order of the software pieces determined by the determination unit.

2. The communication system according to claim 1, wherein based on the traffic flow being a one-way flow, the determination unit determines the migration order of the software pieces to be migrated so that the software pieces are migrated in order from an upstream side.

3. The communication system according to claim 1, wherein based on the traffic flow a bidirectional flow, the determination unit determines the migration order of the software pieces to be migrated so that a software piece at one of ends is migrated first and then a software piece at an end in an opposite direction is migrated

4. The communication system according to claim 1, wherein based on there being a plurality of the traffic flows, the determination unit determines the migration order of the software pieces to be migrated so that a software piece through which a traffic flow with priority set to be high in advance passes is migrated earlier than a software piece through which a traffic flow with the priority set to be low in advance passes.

5. A migration method performed by a communication system, the method comprising:
determining, based on software pieces through which a traffic flow passes, the software pieces running on a predetermined server;
determining, based on an order of the software pieces through which the traffic flow passes, a migration order of the software pieces to be migrated; and
performing a control so that the software pieces are migrated to another server based on the determined migration order of the software pieces to be migrated according to the determining.
